(19) United States
(12) Patent Application Publication
(10) Pub. No.: US 2021/0040834 A1
(43) Pub. Date: Feb. 11, 2021

(54) COGNITIVE ALERTS MONITORING SYSTEMS AND METHODS

(71) Applicant: NABORS DRILLING TECHNOLOGIES USA, INC., Houston, TX (US)

(72) Inventors: Srikanth VALLERU, Spring, TX (US); Namitha VINAY, Cypress, TX (US); Jayaprasad JAYABAL, Houston, TX (US)

(21) Appl. No.: 16/534,112

(22) Filed: Aug. 7, 2019

(51) Int. Cl. E21B 44/00; G08B 21/18; G08B 27/00; G06F 9/54

(52) U.S. Cl. CPC E21B 44/00; G06F 9/542; G08B 27/00; G08B 21/187

(57) ABSTRACT

Systems for adjusting a drilling operation include a plurality of data sources configured to provide data to a controller and the controller. The controller is configured to receive data from a plurality of data sources during a drilling operation, detect an undesirable condition from the received data, determine a cause of the undesirable condition, determine a plurality of potential corrective actions in response to the undesirable condition, provide an alert of the undesirable condition to a user, wherein the alert comprises the cause of the action and the plurality of potential corrective actions, receive instructions to execute a corrective action from the plurality of potential corrective actions, and instruct a device to execute the corrective action.

### BACKGROUND OF THE DISCLOSURE

The drilling, completion, and production stages of the oil well are generally monitored closely to maximize the efficiency and safety of the well during these stages. For example, a wide variety of sensors, measurement apparatuses, devices, and equipment for sensing, measuring, recording, displaying, calculating, processing, and transmitting measured values for operational parameters, including, but not limited to, weight on bit (WOB), rate of penetration (ROP), rotary speed, bit speed, top drive speed, downhole motor speed, and torque on a drill string or on a bit are monitored to optimize drilling operations.

An expert, who is often times a drilling operator with tens of years of experience in the drilling industry generally monitors the operational parameter information to determine if the drilling process is operating at or near an optimal or desired range. Should a problem arise, the expert typically determines a corrective action to solve the problem and provides the corrective action to the operator. But constant expert supervision is costly, particularly when required on-site with the drilling operation, and experts are subject to the limits of their own memory and experience.

Thus, what is needed is a system and method that provides potential corrective actions taken historically in similar wells so that an operator can make a more informed decision regarding what corrective action to take to achieve the greatest opportunity for success. In this way, the operator can avert or mitigate undesirable drilling events during a drilling process.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic of an apparatus according to one or more aspects of the present disclosure.

FIG. 2 is a block diagram schematic of an apparatus according to one or more aspects of the present disclosure.

FIG. 3 is a flow chart of a method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

This disclosure provides apparatuses, systems, and methods for improved monitoring and managing of corrective actions taken at a drilling rig. The apparatuses, systems, and methods allow a user (alternatively referred to herein as an “operator”) or a control system to determine the best course of action to take when a deviation or anomaly is detected. Advantageously, the apparatuses, systems, and methods allow an operator to take more informed actions quickly when he or she is alerted to a problem.

In some embodiments, the alert provided to the operator includes a cause for the alert and options for a corrective action to resolve the undesired condition. The action is generally provided by an operator, such as a subject matter expert, but can also include exemplary historical actions to this type of alert that were performed by the same operator or by other users in similar wells. In various embodiments, the corrective actions are scored and/or ranked by usage. For example, the corrective action that was used the most in the past by users to solve the undesired condition, particularly in a similar well, would be ranked first out of a list containing a plurality of potential corrective actions.

In several embodiments, the corrective actions are scored and/or ranked by success rate. For example, the corrective action having the highest success rate could be scored at 90%, and the corrective action having the lowest success rate could be scored at 55%. Success rate can be determined, for example, by the speed at which the undesired condition is reset and the effectiveness of the corrective action is (e.g., a length of time the undesired condition is avoided or minimized). In several embodiments, a user interface that shows acceptable and unacceptable zones for the condition is provided. The acceptable and unacceptable zones can be determined using rules or through machine learning based on past data, such as from similar wells. In various embodiments, an algorithm tracks a length of time for the condition to go back to the acceptable zone and a second length of time that the condition then stays in the acceptable zone.

In certain embodiments, the apparatuses, systems, and methods have the ability to escalate the alert across multiple levels so that supervisors can apply a corrective action when an operator fails to take appropriate action on a safety alert within a sufficient time. In several embodiments, the supervisor can see the cause of action and corrective actions for safety related alerts, and is given the ability to control what happens at the drilling rig. For example, if a driller does not execute a corrective action within a certain amount of time, the rig manager or remote operations center can execute the corrective action. In one embodiment, a controller may automatically take a corrective action based on the highest success rate if no human user input is provided, particularly in the case of a life-threatening or other dangerous condition.

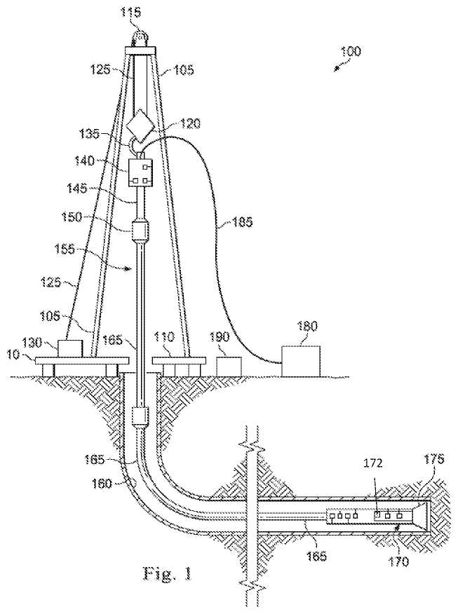

Referring to FIG. 1, illustrated is a schematic view of an apparatus 100 demonstrating one or more aspects of the present disclosure. The apparatus 100 is or includes a land-based drilling rig. However, one or more aspects of the present disclosure are applicable or readily adaptable to any type of drilling rig, such as jack-up rigs, semisubmersibles, drill ships, coil tubing rigs, well service rigs adapted for drilling and/or re-entry operations, and casing drilling rigs, among others within the scope of the present disclosure.

The apparatus 100 includes a mast 105 supporting lifting gear above a rig floor 110. The lifting gear includes a crown block 115 and a traveling block 120. The crown block 115 is coupled at or near the top of the mast 105, and the traveling block 120 hangs from the crown block 115 by a drilling line 125. One end of the drilling line 125 extends from the lifting gear to drawworks 130, which is configured to reel out and reel in the drilling line 125 to cause the traveling block 120 to be lowered and raised relative to the rig floor 110. The other end of the drilling line 125, known as a dead line anchor, is anchored to a fixed position, possibly near the drawworks 130 or elsewhere on the rig.

A hook 135 is attached to the bottom of the traveling block 120. A top drive 140 is suspended from the hook 135. A quill 145 extending from the top drive 140 is attached to a saver sub 150, which is attached to a drill string 155 suspended within a wellbore 160. Alternatively, the quill 145 may be attached to the drill string 155 directly. It should be understood that other conventional techniques for arranging a rig do not require a drilling line, and these are included in the scope of this disclosure. In another aspect (not shown), no quill is present.

The drill string 155 includes interconnected sections of drill pipe 165, a BHA 170, and a drill bit 175. The BHA 170 may include stabilizers, drill collars, and/or measurement-while-drilling (MWD) or wireline conveyed instruments, among other components. The drill bit 175, which may also be referred to herein as a tool, is connected to the bottom of the BHA 170 or is otherwise attached to the drill string 155. One or more pumps 180 may deliver drilling fluid to the drill string 155 through a hose or other conduit 185, which may be fluidically and/or actually connected to the top drive 140.

MWD instruments are generally capable of taking directional surveys in real time, such as through the use of accelerometers and magnetometers to measure the inclination and azimuth of the wellbore at that location. MWD tools can also provide information about the conditions at the drill bit, such as the rotational speed of the drill string, smoothness of the rotation, type and severity of any downhole vibration, downhole temperature, torque and weight on bit, mud flow volume, various fluid pressures, etc. Analysis of the drilling parameter information by an expert allows the operator to drill the well more efficiently, and to ensure that the MWD tool and any other downhole tools, such as mud motors, rotary steering systems, and LWD tools, are operating correctly and are unlikely to fail due to overstress or improper operation.

As shown, the BHA 170 includes a communication subassembly 172 that communicates with the control system 190. The communication subassembly is adapted to send signals to and receive signals from the surface using a communications channel such as mud pulse telemetry, electromagnetic telemetry, or wired drill pipe communications. The communication subassembly may include, for example, a transmitter that generates a signal, such as an acoustic or electromagnetic signal, which is representative of the measured drilling parameters. It will be appreciated by one of ordinary skill in the art that a variety of telemetry systems may be employed, such as wired drill pipe, electromagnetic or other known telemetry systems.

In the exemplary embodiment depicted in FIG. 1, the top drive 140 is used to impart rotary motion to the drill string 155. However, aspects of the present disclosure are also applicable or readily adaptable to implementations utilizing other drive systems, such as a power swivel, a rotary table, a coiled tubing unit, a downhole motor, and/or a conventional rotary rig, among others.

The apparatus 100 also includes a control system 190 configured to control or assist in the control of one or more components of the apparatus 100. For example, the control system 190 may be configured to transmit operational control signals to the drawworks 130, the top drive 140, the BHA 170 and/or the pump 180. The control system 190 may be a stand-alone component installed near the mast 105 and/or other components of the apparatus 100. In some embodiments, the control system 190 is physically displaced at a location separate and apart from the drilling rig.

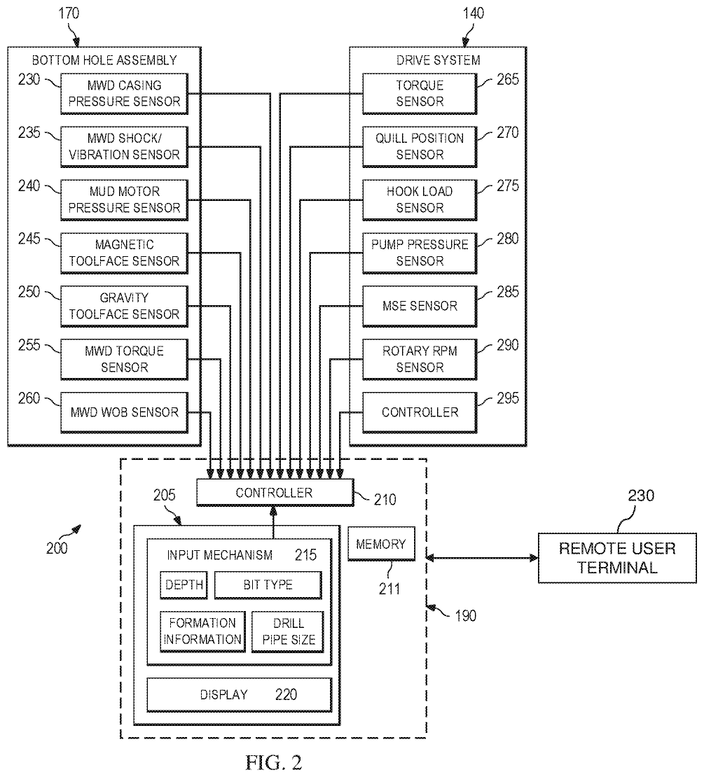

FIG. 2 illustrates a block diagram of a portion of a system 200 according to one or more aspects of the present disclosure. FIG. 2 shows the control system 190, the BHA 170, the top drive 140, identified as a drive system, and a remote user terminal 230. The system 200 may be implemented within the environment and/or the apparatus shown in FIG. 1.

The control system 190 includes a user interface 205, a controller 210, and a memory 211. Depending on the embodiment, these may be discrete components that are interconnected via wired or wireless means. Alternatively, the user interface 205, the controller 210, and the memory 211 may be integral components of a single system.

During drilling operations, the controller 210 receives data from the sensors or any other device, processes such data to determine if corrective action is needed, transmits some of the data in real-time, and stores other data in a storage device (e.g. memory 211). The data gathered by the sensors may be collected by the controller 210 and/or other data collection sources for analysis or other processing. The data collected by the sensors may be used alone or in combination with other data. The data may be collected in one or more databases and/or transmitted on or offsite. The data may be historical data, real time data, or combinations thereof. The data may be used in real time, or stored for later use. As used herein, the term “real time” encompasses a time within 5 minutes of measuring or receiving the data, for example within 1 minute or 30 seconds or less. In some embodiments, real-time data is used and then stored for later use. In other embodiments, real-time data is not immediately used, but is stored for later use. The data may also be combined with historical data or other inputs for further analysis. The data may be stored in separate databases, or combined into a single database.

The control system 190 may generally be positioned at a central data hub, and may be in communication with a remote user terminal 230 via a satellite communications link, for example. In some embodiments, the control system 190 is configured to transmit selected information to a specific remote user terminal 230 (e.g., a user terminal associated with a supervisor, operator, user, or an expert). The control system 190 may also receive instructions or information from the remote user terminal 230. In certain embodiments, the remote user terminal 230 is configured to display drilling or production parameters for the drilling rig, along with the cause of any undesired condition and related corrective actions.

In exemplary embodiments, use of the remote user terminal 230 and access to data processed by the control system 190 is a subscription-type service. More particularly, users may be required to pay a subscription fee or register for a subscription prior to being able to use the monitoring service. The subscription service enables the owner of the drilling rig to control access to the control system 190 and prevent unauthorized parties from sending control signals to the control system 190. In certain embodiments, users must subscribe to the alerts generated by the control system 190 so that alerts can be delivered to certain devices by email, text, or phone.

In certain embodiments, the controller 210 is configured to allow users to define alerts based on information and data that is gathered from the drilling site(s) by various data replication and synchronization techniques. In some embodiments, the controller 210 determines the cause of an undesired condition and provides this information to a user. In several embodiments, the controller 210 provides corrective actions determined by an expert. In various embodiments, the controller 210 accesses the memory 211 to determine what other users facing the same or similar undesired condition did in the past. In exemplary embodiments, the controller 210 scores and/or ranks each corrective action based on how many times the corrective action was used and/or how effective or successful the corrective action was.

The user interface 205 may include an input mechanism 215 permitting a user to input technical thresholds, operational thresholds, rules and algorithms for detecting an undesirable condition, and any other information. In some embodiments, the input mechanism 215 may be used to input additional drilling settings or parameters, such as acceleration, toolface set points, rotation settings, and other set points or input data. A user may input information relating to the drilling parameters of the drill string, such as BHA information or arrangement, drill pipe size, bit type, depth, formation information, among other things. The input mechanism 215 may include a keypad, voice-recognition apparatus, dial, button, switch, slide selector, toggle, joystick, mouse, data base and/or other conventional or future-developed data input device. Such an input mechanism 215 may support data input from local and/or remote locations. Alternatively, or additionally, the input mechanism 215, when included, may permit user-selection of predetermined profiles, algorithms (e.g., machine-learning algorithms), set point values or ranges, such as via one or more drop-down menus. The data may also or alternatively be selected by the controller 210 via the execution of one or more database look-up procedures. In general, the input mechanism 215 and/or other components within the scope of the present disclosure support operation and/or monitoring from stations on the rig site as well as one or more remote locations with a communications link to the system, network, local area network (LAN), wide area network (WAN), Internet, satellite-link, and/or radio, among other means.

The user interface 205 may also include a display 220 for visually presenting information to the user in textual, graphic, or video form. The display 220 may also be utilized by the user to input drilling parameters, limits, or set point data in conjunction with the input mechanism 215. For example, the input mechanism 215 may be integral to or otherwise communicably coupled with the display 220.

In various embodiments, the display 220 presents the cause for the alert and potential corrective actions associated with the alert. In some embodiments, the potential corrective actions are based on the opinions of experts and other users. In several embodiments, the usage and success rate of each potential corrective action are also displayed.

Pre-defined or analytical rules for determining an undesired condition, information from historical and/or offset wells, success rates associated with potential corrective actions, the number of times a potential corrective action was used, and corrective actions taken by a user may be stored in a memory 211 of the control system 190. The memory 211 may be any electronic component capable of storing information and/or instructions. For example, the memory 250 may include random access memory (RAM), read-only memory (ROM), flash memory devices in RAM, optical storage media, erasable programmable read-only memory (EPROM), registers, solid state memory device, hard disk drives, other forms of volatile and non-volatile memory, or combinations thereof. In an embodiment, the memory 211 includes a non-transitory computer-readable medium. Instructions or code may be stored in the memory 211 that are executable by the controller 210.

For example, the memory 211 may include instructions for monitoring a drilling process and recommending corrective actions when an undesired condition is detected. In some embodiments, the corrective actions are ranked and scored by usage and success rate.

The controller 210 is generally arranged to receive data or information from the user, the bottom hole assembly 170, and/or the top drive 140 and process the information to determine if an undesirable condition exists and how to deal with the undesirable condition. The controller 210 may also store updated information to the memory 211, e.g., corrective action taken by a user, along with the related success rate.

The BHA 170 may include one or more sensors, typically a plurality of sensors, located and configured about the BHA to detect parameters relating to the drilling environment, the BHA condition and orientation, and other information. In the embodiment shown in FIG. 2, the BHA 170 includes an MWD casing pressure sensor 230 that is configured to detect an annular pressure value or range at or near the MWD portion of the BHA 170. The casing pressure data detected via the MWD casing pressure sensor 230 may be sent via electronic signal to the controller 210 via wired or wireless transmission.

The BHA 170 may also include an MWD shock/vibration sensor 235 that is configured to detect shock and/or vibration in the MWD portion of the BHA 170. The shock/vibration data detected via the MWD shock/vibration sensor 235 may be sent via electronic signal to the controller 210 via wired or wireless transmission.

The BHA 170 may also include a mud motor ΔP sensor 240 that is configured to detect a pressure differential value or range across the mud motor of the BHA 170. The pressure differential data detected via the mud motor ΔP sensor 240 may be sent via electronic signal to the controller 210 via wired or wireless transmission. The mud motor ΔP may be alternatively or additionally calculated, detected, or otherwise determined at the surface, such as by calculating the difference between the surface standpipe pressure just off-bottom and pressure once the bit touches bottom and starts drilling and experiencing torque.

The BHA 170 may also include a magnetic toolface sensor 245 and a gravity toolface sensor 250 that are cooperatively configured to detect the current toolface. The magnetic toolface sensor 245 may be or include a conventional or future-developed magnetic toolface sensor which detects toolface orientation relative to magnetic north or true north. The gravity toolface sensor 250 may be or include a conventional or future-developed gravity toolface sensor which detects toolface orientation relative to the Earth's gravitational field. In an exemplary embodiment, the magnetic toolface sensor 245 may detect the current toolface when the end of the wellbore is less than about 7° from vertical, and the gravity toolface sensor 250 may detect the current toolface when the end of the wellbore is greater than about 7° from vertical. However, other toolface sensors may also be utilized within the scope of the present disclosure that may be more or less precise or have the same degree of precision, including non-magnetic toolface sensors and non-gravitational inclination sensors. In any case, the toolface orientation detected via the one or more toolface sensors (e.g., sensors 245 and/or 250) may be sent via electronic signal to the controller 210 via wired or wireless transmission.

The BHA 170 may also include an MWD torque sensor 255 that is configured to detect a value or range of values for torque applied to the bit by the motor(s) of the BHA 170. The torque data detected via the MWD torque sensor 255 may be sent via electronic signal to the controller 210 via wired or wireless transmission.

The BHA 170 may also include an MWD weight-on-bit (WOB) sensor 260 that is configured to detect a value or range of values for WOB at or near the BHA 170. The WOB data detected via the MWD WOB sensor 260 may be sent via electronic signal to the controller 210 via wired or wireless transmission.

The top drive 140 may also or alternatively may include one or more sensors or detectors that provide information that may be considered by the controller 210 when it evaluates data quality. In this embodiment, the top drive 140 includes a rotary torque sensor 265 that is configured to detect a value or range of the reactive torsion of the quill 145 or drill string 155. The top drive 140 also includes a quill position sensor 270 that is configured to detect a value or range of the rotational position of the quill, such as relative to true north or another stationary reference. The rotary torque and quill position data detected via sensors 265 and 270, respectively, may be sent via electronic signal to the controller 210 via wired or wireless transmission.

The top drive 140 may also include a hook load sensor 275, a pump pressure sensor or gauge 280, a mechanical specific energy (MSE) sensor 285, and a rotary RPM sensor 290.

The hook load sensor 275 detects the load on the hook 135 as it suspends the top drive 140 and the drill string 155. The hook load detected via the hook load sensor 275 may be sent via electronic signal to the controller 210 via wired or wireless transmission.

The pump pressure sensor or gauge 280 is configured to detect the pressure of the pump providing mud or otherwise powering the BHA from the surface. The pump pressure detected by the pump sensor pressure or gauge 280 may be sent via electronic signal to the controller 210 via wired or wireless transmission.

The mechanical specific energy (MSE) sensor 285 is configured to detect the MSE representing the amount of energy required per unit volume of drilled rock. In some embodiments, the MSE is not directly sensed, but is calculated based on sensed data at the controller 210 or other controller about the apparatus 100.

The rotary RPM sensor 290 is configured to detect the rotary RPM of the drill string. This may be measured at the top drive or elsewhere, such as at surface portion of the drill string. The RPM detected by the RPM sensor 290 may be sent via electronic signal to the controller 210 via wired or wireless transmission.

In FIG. 2, the top drive 140 also includes a controller 295 and/or other means for controlling the rotational position, speed and direction of the quill 145 or other drill string component coupled to the top drive 140 (such as the quill 145 shown in FIG. 1). Depending on the embodiment, the controller 295 may be integral with or may form a part of the controller 210.

The controller 210 is configured to receive detected information (i.e., measured or calculated) from the user interface 205, the BHA 170, and/or the top drive 140, and utilize such information to continuously, periodically, or otherwise operate to maintain the safety of the well. The controller 210 may be further configured to generate a control signal, such as via intelligent adaptive control, and provide the control signal to the top drive 140 to set, adjust and/or maintain drilling parameters in order to most effectively perform a drilling operation.

Moreover, as in the exemplary embodiment depicted in FIG. 2, the controller 295 of the top drive 140 may be configured to generate and transmit a signal to the controller 210. Consequently, the controller 295 of the top drive 140 may be configured to influence drilling parameters.

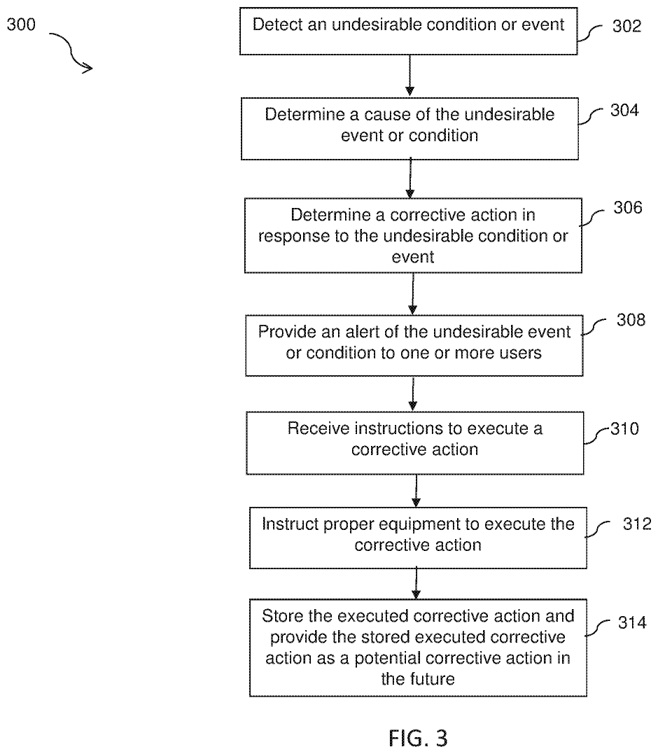

FIG. 3 is a flow chart showing an exemplary method 300 for monitoring a drilling rig. The method begins at step 302, where the controller 210 detects an undesirable condition or event. Detecting one or more undesirable drilling conditions or events may involve comparing values derived from the surface and/or downhole measurement data with threshold values. Examples of undesirable conditions or events include kick, stuck pipe, lost circulation, drill bit stick-slip, plugged drill bit nozzles, drill bit nozzle washout, over- or under-sized gauge hole, drill bit wear, mud motor performance loss, drilling-induced formation fractures, ballooning, poor hole cleaning, pipe washout, destructive vibration, accidental sidetracking, and twist-off onset.

An undesirable condition or event is generally pre-defined and can be based on events detected through pre-defined rules and/or through anomalies detected when there is a deviation from expected correlations found from historical wells and offset wells using real-time analytics. In some embodiments, the pre-defined rules are based on a collection of properties and behaviors that can be defined and stored in a database, which allows users to define alerts of different kinds by using various permutations and combinations of the properties and behaviors. A combination of single or multiple events or sensor data can be used to determine if an undesirable condition is present.

At step 304, the controller 210 determines a cause of the undesirable event or condition. The ability to include the cause for the alert in the alert provides the user or operator with more insight into the undesirable event or condition. For example, if a well control event is detected, rather than just providing the absolute value of flow back, the controller 210 can show that flow back has risen by x % in the last y seconds.

At step 306, the controller 210 determines a possible corrective action in response to the detected undesired event or condition. In various embodiments, the controller 210 transmits data (e.g., well parameters) related to the undesired event or condition to an expert at remote user terminal 230, and the expert provides one or more corrective actions for a user to take. For example, when a parameter at the drilling rig is outside of a normal range, the controller 210 alerts the expert of the potential problem and allows the expert to send a control or warning message to the specific drilling rig having the problem to correct the problem.

In certain embodiments, the controller 210 also provides recommendations based on what it has learned from other users and other wells. In exemplary embodiments, the controller 210 collects actions most performed by other users and ranks and/or scores them based on success rates and/or usage.

In some embodiments, sensed parameters to be transmitted from the control system 190 to the remote user terminal 230 may be temporarily stored at the well location before being transmitted. More particularly, in the situation where the communications medium between the control system 190 and the remote user terminal 230 is temporarily inoperative, the controller 210 may be configured to store the sensed parameters in memory 211. In this scenario, the communications medium may be monitored to determine when communications are possible, and the stored data that relates to any alert specified by the expert user may be transmitted in an expedited manner (with priority over other data).

At step 308, the controller 210 provides an alert of the undesirable event or condition to one or more users. In various embodiments, the controller 210 displays the cause of the alert and the related corrective actions on a user interface (e.g., user interface 205). In various embodiments, the corrective actions are scored and ranked based on how many times the action was used and how successful it was in correcting the undesired condition, and the rank and score are also displayed on the user interface.

For example, if bit wear is detected, the corrective action suggested by an expert may be to lower the weight on bit generally, for a period of time, during a particular operation (such as when the bit has an ROP greater than a threshold), or while the BHA is drilling through a particular formation. In addition to providing the potential corrective action to a user, controller 210 can also show how many times the users who have operated in the same conditions have followed this action and the success rate of this action. Along with this information, the controller 210 may also provide recommendations on other actions taken by other users and rank these actions by usage and/or score these actions by success rate. This way, the user is better informed before taking appropriate measures to correct the problem.

In several embodiments, the control system 190 allows users to configure the alerts such that the alerts are role-based. For example, if a bit wear is detected, the driller is alerted first because the driller will be able to take the action. In such an event that the driller does not take the corrective action in time, however, a role-based hierarchy can be built in such that the rig manager/toolpusher can override the operator and execute the selected corrective action.

In exemplary embodiments, the control system 190 uses an escalation concept, which is generally the process of notifying a different group of people or agents when an initial group could not or was not able to take action in response to an alert for some reason. This escalation to another group or monitoring person is generally done to prevent a problem situation from going unaddressed. Therefore, in some embodiments, an alert that is available today may have escalation policies that are based on the alert itself, and if the notification on the alert has not been acknowledged and acted upon within a predetermined time period, an alert engine may escalate it. The alert engine may be a software routine or a hardware device configured to monitor alerts and responses thereto to determine when an escalation alert or message should be sent. The alert engine may be positioned in the control system 190, or in a separate location that is in communication with the control system 190. In various embodiments, the alerts engine fails to receive a corrective action even after the alert is escalated, and controller 210 automatically selects and executes the corrective action having the highest usage rate and highest success rate.

Each user that could be a notification recipient could have multiple channels of notification available, e.g., via email, phone, pager, SMS (text messaging), social media app (custom-built or commonly used), fax, etc. Ideally, the notification channel is available on the same device a user would need to implement or accept a corrective action, e.g., a mobile device (including telephone, tablet, or otherwise), or a computer connected to the internet. Escalation of a notification may happen along the same channels, as well. For instance, the first notification goes to the email addresses of all the recipients. If an acknowledgement is not received within a certain amount of time, a notification is sent to the recipients' hand-held device. The notification is then escalated to the recipients' mobile phone where a pre-recorded message is played back. Once all the channels of notification are exhausted for the first level of recipients and no acknowledgement occurs, then the alert may be escalated to the next level of recipients who may have their own independent set of notification channels.

At step 310, the controller 210 receives instructions to execute a corrective action.

At step 312, the controller 210 instructs the proper equipment to execute the corrective action. For example, the controller 210 can instruct the BHA 170, the top drive 140, and/or pump 180 to perform the corrective action.

At step 314, the controller 210 stores the executed corrective action and provides the stored executed corrective action as a potential corrective action in the future. The action taken by the user, along with the success rate of this action is typically tracked by the controller 210 and stored in memory 211 so they can be used to make future recommendations. In other words, the controller 210 “learns” from the actions taken by the user and uses this information to provide future corrective actions. The action taken by the user can also help supervisors determine which users need training.

In view of all of the above and the figures, one of ordinary skill in the art will readily recognize that the present disclosure relates to systems and methods for adjusting a drilling operation. In one aspect, the present disclosure is directed to a system that includes a plurality of data sources configured to provide data to a controller and a controller. The controller is configured to receive data from the plurality of data sources during a drilling operation, detect an undesirable condition from the received data, determine a cause of the undesirable condition, determine a plurality of potential corrective actions in response to the undesirable condition, provide an alert of the undesirable condition to a user, wherein the alert comprises the cause of the action and the plurality of potential corrective actions, receive instructions to execute a corrective action from the plurality of potential corrective actions, and instruct a device to execute the corrective action.

In a second aspect, the present disclosure is directed to a method of adjusting a drilling operation. The method includes receiving data from a plurality of data sources during a drilling operation, detecting an undesirable condition from the received data, determining a cause of the undesirable condition, transmitting the undesirable condition to a subject matter expert, receiving a corrective action from the subject matter expert, determining a historical corrective action that was taken for the undesirable condition, providing an alert of the undesirable condition to a user, wherein the alert comprises the cause of the undesirable condition and a plurality of potential corrective actions, and the plurality of potential corrective actions comprises the corrective action received from the subject matter expert and the historical corrective action, receiving instructions to execute a corrective action from the plurality of potential corrective actions, and instructing a device to execute the corrective action.

In a third aspect, the present disclosure is directed to a non-transitory machine-readable medium having stored thereon machine-readable instructions executable to cause a machine to perform operations. The operations include receiving data from a plurality of data sources during a drilling operation, detecting an undesirable condition from the received data, determining a cause of the undesirable condition, determining a plurality of potential corrective actions in response to the undesirable condition, determining a success rate for each of the plurality of potential corrective actions, scoring each of the plurality of potential corrective actions based on the success rate, determining a number of times each of the plurality of potential corrective actions was used, ranking each of the plurality of potential corrective actions based on the determined number of times each of the plurality of potential corrective actions was used, providing an alert of the undesirable condition to a user, wherein the alert comprises the cause of the action, the plurality of potential corrective actions, the rank of each of the plurality of potential corrective actions, and the score for each of the plurality of potential corrective actions, receiving instructions to execute a corrective action from the plurality of potential corrective actions, and instructing a device to execute the corrective action.

Thus, various systems, apparatuses, methods, etc. have been described herein. Although embodiments have been described with reference to specific example embodiments, it will be evident that various modifications and changes may be made to these embodiments without departing from the broader spirit and scope of the system, apparatus, method, and any other embodiments described and/or claimed herein. Further, elements of different embodiments in the present disclosure may be combined in various different manners to disclose additional embodiments still within the scope of the present embodiments. Additionally, the specification and drawings are to be regarded in an illustrative rather than a restrictive sense.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. § 112, paragraph 6 for any limitations of any of the claims herein, except for those in which the claim expressly uses the word “means” together with an associated function.

What is claimed is:

1. A system, comprising:
a plurality of data sources configured to provide data to a controller; and
a controller configured to:
receive data from the plurality of data sources during a drilling operation;
detect an undesirable condition from the received data;
determine a cause of the undesirable condition;
determine a plurality of potential corrective actions in response to the undesirable condition;
provide an alert of the undesirable condition to a user, wherein the alert comprises the cause of the action and the plurality of potential corrective actions;
receive instructions to execute a corrective action from the plurality of potential corrective actions; and
instruct a device to execute the corrective action.

2. The system of claim 1, wherein the plurality of data sources comprises a plurality of sensors in communication with the controller.

3. The system of claim 1, wherein the controller is further configured to transmit the undesirable condition to a subject matter expert and receive the corrective action from the subject matter expert.

4. The system of claim 1, wherein the controller is further configured to retrieve a historical corrective action from a database.

5. The system of claim 1, wherein the controller is further configured to determine a success rate of each of the plurality of potential corrective actions.

6. The system of claim 5, wherein the controller is further configured to score each of the plurality of potential corrective actions based on the determined success rate.

7. The system of claim 1, wherein the controller is further configured to determine a number of times each of the plurality of potential corrective actions was used.

8. The system of claim 7, wherein the controller is further configured to rank each of the plurality of potential corrective actions based on the determined number of times each of the plurality of corrective actions was used.

9. The system of claim 1, further comprising a remote user terminal in communication with the controller.

10. The system of claim 9, wherein the controller is configured to provide the alert to the remote user terminal, and the remote user terminal is configured to provide the instructions to the controller to execute the corrective action.

11. The system of claim 1, wherein the controller is further configured to store the executed corrective action and provide the stored executed corrective action as one of a plurality of potential corrective actions in the future.

12. A method of adjusting a drilling operation, which comprises
receiving data from a plurality of data sources during a drilling operation;
detecting an undesirable condition from the received data;
determining a cause of the undesirable condition;
transmitting the undesirable condition to a subject matter expert;
receiving a corrective action from the subject matter expert;
determining a historical corrective action that was taken for the undesirable condition;
providing an alert of the undesirable condition to a user, wherein the alert comprises the cause of the undesirable condition and a plurality of potential corrective actions, and the plurality of potential corrective actions comprises the corrective action received from the subject matter expert and the historical corrective action;
receiving instructions to execute a corrective action from the plurality of potential corrective actions; and
instructing a device to execute the corrective action.

13. The method of claim 12, further comprising determining a success rate for each of the plurality of potential corrective actions and a number of times each of the plurality of potential corrective actions was used.

14. The method of claim 13, further comprising ranking each of the plurality of potential corrective actions based on the determined success rate and scoring each of the plurality of potential corrective actions based on the determined number of times each of the plurality of potential corrective actions was used.

15. The method of claim 14, further comprising providing the rank and the score of each of the plurality of potential corrective actions to the user.

16. The method of claim 12, further comprising determining that the user failed to provide the instructions to execute the corrective action within a predetermined period of time.

17. The method of claim 16, further comprising transmitting the alert to a supervisor of the user and receiving the instructions to execute the corrective action from the supervisor.

18. A non-transitory machine-readable medium having stored thereon machine-readable instructions executable to cause a machine to perform operations that, when executed, comprise:
receiving data from a plurality of data sources during a drilling operation;
detecting an undesirable condition from the received data;
determining a cause of the undesirable condition;
determining a plurality of potential corrective actions in response to the undesirable condition;
determining a success rate for each of the plurality of potential corrective actions;
scoring each of the plurality of potential corrective actions based on the success rate;
determining a number of times each of the plurality of potential corrective actions was used;
ranking each of the plurality of potential corrective actions based on the determined number of times each of the plurality of potential corrective actions was used;
providing an alert of the undesirable condition to a user, wherein the alert comprises the cause of the action, the plurality of potential corrective actions, the rank of each of the plurality of potential corrective actions, and the score for each of the plurality of potential corrective actions;
receiving instructions to execute a corrective action from the plurality of potential corrective actions; and
instructing a device to execute the corrective action.

19. The non-transitory machine-readable medium of claim 18, wherein the operations further comprise determining that the user failed to provide the instructions to execute the corrective action within a predetermined period of time.

20. The non-transitory machine-readable medium of claim 19, wherein the operations further comprise transmitting the alert to a supervisor of the user and receiving the instructions to execute the corrective action from the supervisor.
